(19) United States
(12) Patent Application Publication
(10) Pub. No.: US 2019/0181526 A1
(43) Pub. Date: Jun. 13, 2019

(54) DUAL-BAND SYSTEM AND DIPLEXER THEREOF

(71) Applicant: Shenzhen South Silicon Valley Microelectronics Co. Limited, Hsinchu County (TW)

(72) Inventor: Ming-Hao Yeh, Hsinchu County (TW)

(21) Appl. No.: 15/835,941

(22) Filed: Dec. 8, 2017

(51) Int. Cl. H01P 1/213

(52) U.S. Cl. CPC H01P 1/213

(57) ABSTRACT

A diplexer has a first terminal, a second terminal and a third terminal. The diplexer includes a first filter and a second filter. The first filter is connected between the first terminal and the third terminal. A first band signal is operated in a first frequency band and transmitted through a first path between the first terminal and the third terminal. The second filter is connected between the second terminal and the third terminal. A second band signal is operated in a second frequency band and transmitted through a second path between the second terminal and the third terminal. The first filter is a first band-rejection filter for stopping the second band signal.

### FIELD OF THE INVENTION

The present invention relates to a microwave system and a component, and more particularly to a dual-band system and a diplexer thereof.

### BACKGROUND OF THE INVENTION

In a wireless networking technology, a dual-band system uses two different standard frequencies to transmit signals. For example, a dual-band router is used in a dual-band WiFi system to support the 2.4G frequency band and the 5G frequency band. The term 2.4G denotes the frequency of 2.4 GHz. The term 5G denotes the frequency of 5 GHz.

FIG. 1 schematically illustrates a conventional dual-band system. As shown in FIG. 1, the dual-band system comprises a dual-band IC 10, a first band antenna 12 and a second band antenna 14. The dual-band IC 10 has a first terminal “a” and a second terminal “b”. The first band antenna 12 is connected with the first terminal “a”. The second band antenna 14 is connected with the second terminal “b”.

A first band signal is transmitted through a first band signal path between the first terminal “a” of the dual-band IC 10 and the first band antenna 12. A second band signal is transmitted through a second band signal path between the second terminal “b” of the dual-band IC 10 and the second band antenna 14.

In a dual-band WiFi system, the first terminal “a” is a 2.4G terminal, and the second terminal “b” is a 5G terminal. That is, the first band antenna 12 is a 2.4G antenna, and the second band antenna 14 is a 5G antenna.

Since the first band antenna 12 and the second band antenna 14 of the dual-band system as shown in FIG. 1 are respective antennas, the mass production cost of the dual-band system is high. Moreover, the first band signal and the second band signal interfere with each other through the antenna radiation.

FIG. 2 schematically illustrates another conventional dual-band system. As shown in FIG. 2, the dual-band system comprises a dual-band IC 20, an active switch 22 and a dual-band antenna 24. The dual-band IC 20 has a first terminal “a”, a second terminal “b” and a control terminal “c”. The active switch 22 has a first terminal t1, a second terminal t2, a third terminal t3 and a control terminal ctrl. The first terminal t1 of the active switch 22 is connected with the first terminal “a” of the dual-band IC 20. The second terminal t2 of the active switch 22 is connected with the second terminal “b” of the dual-band IC 20. The third terminal t3 of the active switch 22 is connected with the dual-band antenna 24. The control terminal “c” of the dual-band IC 20 is connected with the control terminal ctrl of the active switch 22.

In a dual-band WiFi system, the first terminal “a” is a 2.4G terminal, and the second terminal “b” is a 5G terminal. That is, the dual-band antenna 24 is a 2.4G/5G antenna.

In the dual-band system of FIG. 2, one of a first band signal path and a second band signal path of the active switch 22 is selected according to a control signal from the control terminal “c” of the dual-band IC 20.

Obviously, the dual-band IC 20 needs an additional control pin to provide the control signal to operate the active switch 22. In addition, the first band signal path and the second band signal path cannot be used simultaneously. Since the first band signal path and the second band signal path are employed according to time allocation, the utilization efficiency is impaired. Moreover, the active switch 22 requires extra power consumption, and the active switch 22 is not cost-effective.

### SUMMARY OF THE INVENTION

An embodiment of the present invention provides a diplexer. The diplexer has a first terminal, a second terminal and a third terminal. The diplexer includes a first filter and a second filter. The first filter is connected between the first terminal and the third terminal. A first band signal is operated in a first frequency band and transmitted through a first path between the first terminal and the third terminal. The second filter is connected between the second terminal and the third terminal. A second band signal is operated in a second frequency band and transmitted through a second path between the second terminal and the third terminal. The first filter is a first band-rejection filter for stopping the second band signal.

Another embodiment of the present invention provides a dual-band system. The dual-band system includes a dual-band IC, a diplexer, a first matching circuit, a second matching circuit and a dual-band antenna. The dual-band IC has a first terminal and a second terminal. The diplexer has a third terminal, a fourth terminal and a fifth terminal. The diplexer includes a first filter and a second filter. The first filter is connected between the third terminal and the fifth terminal. A first band signal is operated in a first frequency band and transmitted through a first path between the third terminal and the fifth terminal. The second filter is connected between the fourth terminal and the fifth terminal. A second band signal is operated in a second frequency band and transmitted through a second path between the fourth terminal and the fifth terminal. The first matching circuit is connected between the first terminal and the third terminal. The second matching circuit is connected between the second terminal and the fourth terminal. The dual-band antenna is connected with the fifth terminal. The first filter is a first band-rejection filter for stopping the second band signal.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) schematically illustrates a conventional dual-band system;

FIG. 2 (prior art) schematically illustrates another conventional dual-band system;

FIG. 3 schematically illustrates the architecture of a dual-band system according to a first embodiment of the present invention;

FIG. 4A schematically illustrates a first exemplary diplexer of the dual-band system according to the first embodiment of the present invention;

FIG. 4B schematically illustrates a second exemplary diplexer of the dual-band system according to the first embodiment of the present invention;

FIG. 5 is a schematic circuit diagram illustrating the second exemplary diplexer of the dual-band system according to the first embodiment of the present invention;

FIG. 6 schematically illustrates the architecture of a dual-band system according to a second embodiment of the present invention; and

FIG. 7 is a schematic circuit diagram illustrating the diplexer, the first matching circuit and the second matching circuit of the dual-band system according to the second embodiment of the present invention.

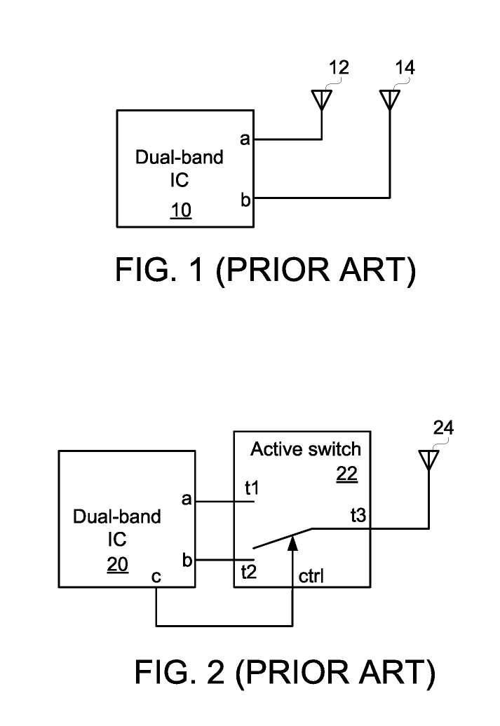

### DETAILED DESCRIPTION OF PREFERRED EMBODIMENTS

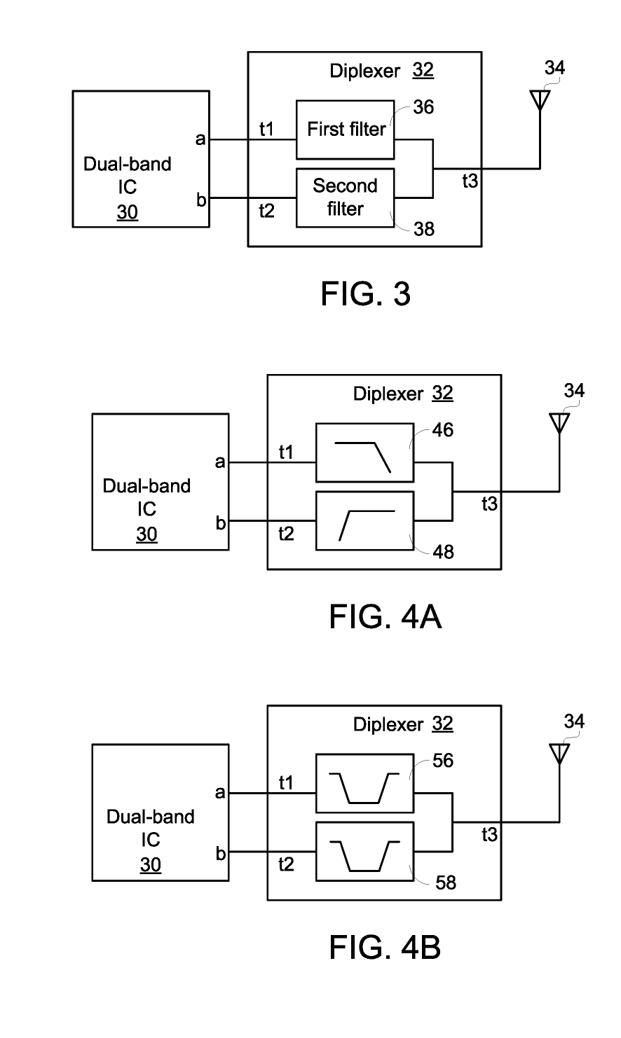

FIG. 3 schematically illustrates the architecture of a dual-band system according to a first embodiment of the present invention. In this embodiment, the dual-band system comprises a dual-band IC 30, a diplexer 32 and a dual-band antenna 34. The dual-band IC 30 has a first terminal “a” and a second terminal “b”. The diplexer 32 has a first terminal t1, a second terminal t2 and a third terminal t3. The first terminal t1 of the diplexer 32 is connected with the first terminal “a” of the dual-band IC 30. The second terminal t2 of the diplexer 32 is connected with the second terminal “b” of the dual-band IC 30. The third terminal t3 of the diplexer 32 is connected with the dual-band antenna 34.

The diplexer 32 comprises a first filter 36 and a second filter 38. The first filter 36 is connected between the first terminal t1 and the third terminal t3 of the diplexer 32. The second filter 38 is connected between the second terminal t2 and the third terminal t3 of the diplexer 32. A first band signal is transmitted through a first band signal path between the first terminal “a” of the dual-band IC 30 and the dual-band antenna 34. A second band signal is transmitted through a second band signal path between the second terminal “b” of the dual-band IC 30 and the dual-band antenna 34.

Various examples of the combination of the first filter and the second filter in the diplexer 32 will be described as follows.

FIG. 4A schematically illustrates a first exemplary diplexer of the dual-band system according to the first embodiment of the present invention. In this embodiment, the first filter of the diplexer 32 is a low pass filter 46, and the second filter of the diplexer 32 is a high pass filter 48. The low pass filter 46 is connected between the first terminal t1 and the third terminal t3 of the diplexer 32. The high pass filter 48 is connected between the second terminal t2 and the third terminal t3 of the diplexer 32.

In a dual-band WiFi system, the first terminal “a” is a 2.4G terminal, and the second terminal “b” is a 5G terminal. That is, the dual-band antenna 34 is a 2.4G/5G antenna. The cut-off frequency of the low pass filter 46 is in the range between 2.4 GHz and 5 GHz. The cut-off frequency of the high pass filter 48 is in the range between 2.4 GHz and 5 GHz.

Consequently, the 2.4G band signal can pass the low pass filter 46, but the 5G band signal cannot pass the low pass filter 46. Moreover, the 5G band signal can pass the high pass filter 48, but the 2.4G band signal cannot pass the high pass filter 48. In other words, the 2.4G band signal is transmitted through the 2.4G band signal path between the first terminal “a” of the dual-band IC 30 and the dual-band antenna 34, and the 5G band signal is transmitted through the 5G band signal path between the second terminal “b” of the dual-band IC 30 and the dual-band antenna 34.

FIG. 4B schematically illustrates a second exemplary diplexer of the dual-band system according to the first embodiment of the present invention. In this embodiment, the first filter of the diplexer 32 is a first band-rejection filter 56, and the second filter of the diplexer 32 is a second band-rejection filter 58. The first band-rejection filter 56 is connected between the first terminal t1 and the third terminal t3 of the diplexer 32. The second band-rejection filter 58 is connected between the second terminal t2 and the third terminal t3 of the diplexer 32. The band-stop frequency of the first band-rejection filter 56 is in the range of the second band frequency. Consequently, the second band signal is stopped by the first band-rejection filter 56. The band-stop frequency of the second band-rejection filter 58 in the range of the first band frequency. Consequently, the first band signal is stopped by the second band-rejection filter 58.

In a dual-band WiFi system, the first terminal “a” is a 2.4G terminal, and the second terminal “b” is a 5G terminal. That is, the dual-band antenna 34 is a 2.4G/5G antenna. That is, the 2.4G band signal is stopped by the second band-rejection filter 58, and the 5G band signal is stopped by the first band-rejection filter 56. In other words, the 2.4G band signal is transmitted through the 2.4G band signal path between the first terminal “a” of the dual-band IC 30 and the dual-band antenna 34, and the 5G band signal is transmitted through the 5G band signal path between the second terminal “b” of the dual-band IC 30 and the dual-band antenna 34.

The above two exemplary diplexers are presented herein for purpose of illustration and description only. That is, other types of filters may be combined together as the diplexer of the present invention.

In a third exemplary diplexer 32, the first filter is a band-rejection filter, and the second filter is a high pass filter. The 5G band signal is stopped by the first filter, but the 2.4G band signal is transmitted through the first filter. The 5G band signal is transmitted through the second filter, but the 2.4G band signal is not transmitted through the second filter.

In a fourth exemplary diplexer 32, the first filter is a low pass filter, and the second filter is a band-rejection filter. The 2.4G band signal is transmitted through the first filter, but the 5G band signal is not transmitted through the first filter. The 2.4G band signal is stopped by the second filter, but the 5G band signal is transmitted through the second filter.

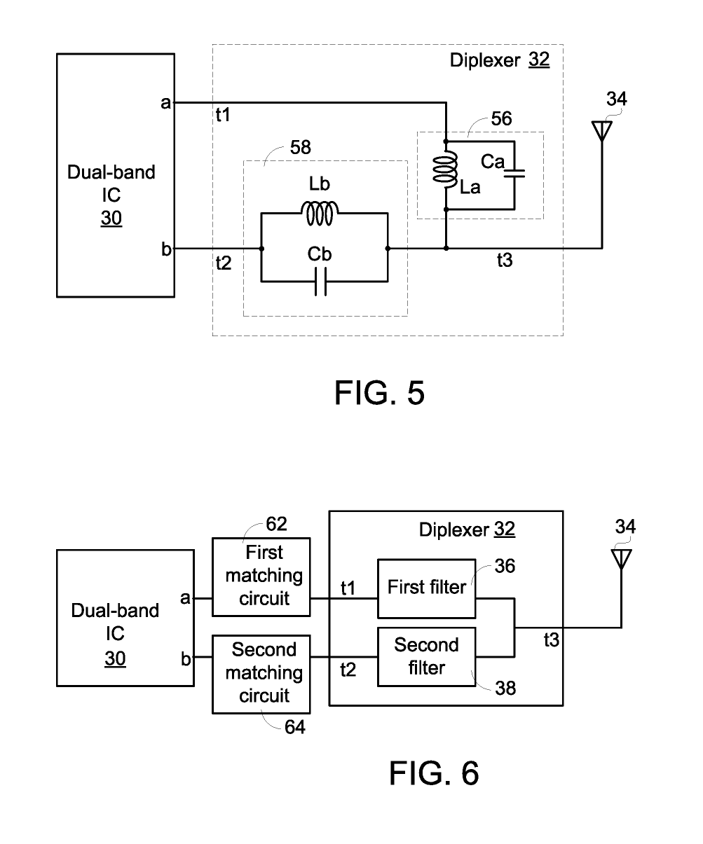

FIG. 5 is a schematic circuit diagram illustrating the second exemplary diplexer of the dual-band system according to the first embodiment of the present invention. The first band-rejection filter 56 of the diplexer 32 comprises a first inductor La and a first capacitor Ca, which are connected with each other in parallel. The second band-rejection filter 58 of the diplexer 32 comprises a second inductor Lb and a second capacitor Cb, which are connected with each other in parallel.

The band-stop frequency of the first band-rejection filter 56 is in the range between 4 GHz and 6 GHz. Consequently, the 5G band signal is stopped by the first band-rejection filter 56, but the 2.4G band signal is not stopped by the first band-rejection filter 56. The inductance of the first inductor La and the capacitance of the first capacitor Ca are suitably selected to form the first band-rejection filter 56. For example, the inductance of the first inductor La is in the range between 1 nH and 10 nH, and the capacitance of the first capacitor Ca is in the range between 0.1 pF and 2 pF.

Moreover, the first inductor La contains a parasitic capacitor. Consequently, in another embodiment, the first band-rejection filter 56 comprises the first inductor La only. For example, the inductance of the first inductor La is 5.6 nH, and the parasitic capacitance of the first inductor La is 0.2 pF. Consequently, the band-stop frequency of the first band-rejection filter 56 is about 5 GHz. In other words, the first band-rejection filter 56 with the first inductor La is feasible.

The band-stop frequency of the second band-rejection filter 58 is in the range between 2.2 GHz and 2.6 GHz. Consequently, the 2.4G band signal is stopped by the second band-rejection filter 58, but the 5G band signal is not stopped by the second band-rejection filter 58. The inductance of the second inductor Lb and the capacitance of the second capacitor Cb are suitably selected to form the second band-rejection filter 58. For example, the inductance of the second inductor Lb is in the range between 1 nH and 10 nH, and the capacitance of the second capacitor Cb is in the range between 0.1 pF and 5 pF.

In other words, the 2.4G band signal is transmitted through the 2.4G band signal path between the first terminal “a” of the dual-band IC 30 and the dual-band antenna 34, and the 5G band signal is transmitted through the 5G band signal path between the second terminal “b” of the dual-band IC 30 and the dual-band antenna 34.

FIG. 6 schematically illustrates the architecture of a dual-band system according to a second embodiment of the present invention. In this embodiment, the dual-band system comprises a dual-band IC 30, a diplexer 32, a dual-band antenna 34, a first matching circuit 62 and a second matching circuit 64. The dual-band IC 30 has a first terminal “a” and a second terminal “b”. The diplexer 32 has a first terminal t1, a second terminal t2 and a third terminal t3.

In comparison with the first embodiment, the dual-band system of this embodiment further comprises the first matching circuit 62 and the second matching circuit 64. The first matching circuit 62 is connected between the first terminal “a” of the dual-band IC 30 and the first terminal t1 of the diplexer 32. The second matching circuit 64 is connected between the second terminal “b” of the dual-band IC 30 and the second terminal t2 of the diplexer 32. In case that both of the first matching circuit 62 and the second matching circuit 64 are conducting wires, the dual-band system of this embodiment is identical to the dual-band system of the first embodiment. The examples of the diplexer 32 used in the dual-band system of the first embodiment are also applied to the dual-band system of this embodiment.

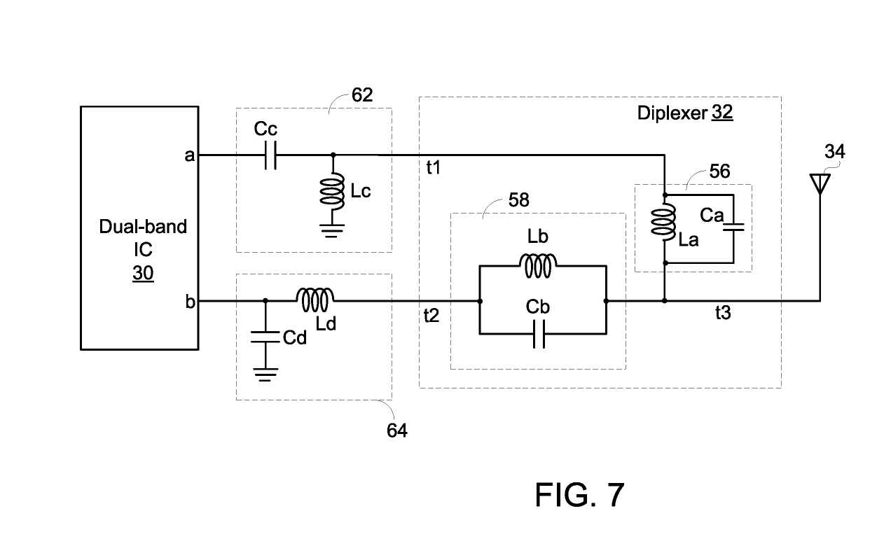

FIG. 7 is a schematic circuit diagram illustrating the diplexer, the first matching circuit and the second matching circuit of the dual-band system according to the second embodiment of the present invention. The circuitry of the diplexer is similar to that of FIG. 5, and is not redundantly described herein.

The first matching circuit 62 comprises an inductor Lc and a capacitor Cc. The inductor Lc is connected between a ground terminal and the first terminal t1 of the diplexer 32. The capacitor Cc is connected between the first terminal “a” of the dual-band IC 30 and the first terminal t1 of the diplexer 32. For example, the inductance of the inductor Lc is about 9.1 nF, and the capacitance of the capacitor Cc is about 1 pF.

The second matching circuit 64 comprises an inductor Ld and a capacitor Cd. The inductor Ld is connected between the second terminal “b” of the dual-band IC 30 and the second terminal t2 of the diplexer 32. The capacitor Cd is connected between the second terminal “b” of the dual-band IC 30 and the ground terminal. For example, the inductance of the inductor Ld is about 1 nF, and the capacitance of the capacitor Cd is about 0.2 pF.

The circuitry structures of the first matching circuit 62 and the second matching circuit 64 are not restricted. It is noted that numerous modifications and alterations of the first matching circuit and the second matching circuit may be made while retaining the teachings of the invention.

From the above descriptions, the present invention provides a dual-band system and a diplexer of the dual-band system. The diplexer of the dual-band system comprises at least one band-rejection filter. Since the band-rejection filter is composed of simple electronic components, the band-rejection filter is cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A diplexer having a first terminal, a second terminal and a third terminal, the diplexer comprising:
a first filter connected between the first terminal and the third terminal, wherein a first band signal is operated in a first frequency band and transmitted through a first path between the first terminal and the third terminal; and
a second filter connected between the second terminal and the third terminal, wherein a second band signal is operated in a second frequency band and transmitted through a second path between the second terminal and the third terminal,
wherein the first filter is a first band-rejection filter for stopping the second band signal.

2. The diplexer as claimed in claim 1, wherein the second frequency band is higher than the first frequency band, and the first band-rejection filter comprises a first inductor and a first capacitor, wherein the first inductor is connected between the first terminal and the third terminal, and the first capacitor is connected between the first terminal and the third terminal.

3. The diplexer as claimed in claim 2, wherein a first band-stop frequency of the first band-rejection filter is in the second frequency band.

4. The diplexer as claimed in claim 3, wherein an inductance of the first inductor is in a range between 1 nH and 10 nH, and a capacitance of the first capacitor is in a range between 0.1 pF and 2 pF.

5. The diplexer as claimed in claim 4, wherein the first capacitor is a parasitic capacitor of the first inductor.

6. The diplexer as claimed in claim 2, wherein the second filter is a second band-rejection filter for stopping the first band signal.

7. The diplexer as claimed in claim 6, wherein the second band-rejection filter comprises a second inductor and a second capacitor, wherein the second inductor is connected between the second terminal and the third terminal, and the second capacitor is connected between the second terminal and the third terminal.

8. The diplexer as claimed in claim 7, wherein a second band-stop frequency of the second band-rejection filter is in the first frequency band.

9. The diplexer as claimed in claim 8, wherein an inductance of the second inductor is in a range between 1 nH and 10 nH, and a capacitance of the second capacitor is in a range between 0.1 pF and 5 pF.

10. A dual-band system, comprising:
a dual-band IC having a first terminal and a second terminal;
a diplexer having a third terminal, a fourth terminal and a fifth terminal, and comprising a first filter and a second filter, wherein the first filter is connected between the third terminal and the fifth terminal, a first band signal is operated in a first frequency band and transmitted through a first path between the third terminal and the fifth terminal, the second filter is connected between the fourth terminal and the fifth terminal, and a second band signal is operated in a second frequency band and transmitted through a second path between the fourth terminal and the fifth terminal;
a first matching circuit connected between the first terminal and the third terminal;
a second matching circuit connected between the second terminal and the fourth terminal; and
a dual-band antenna connected with the fifth terminal,
wherein the first filter is a first band-rejection filter for stopping the second band signal.

11. The dual-band system as claimed in claim 10, wherein the second frequency band is higher than the first frequency band, and the first band-rejection filter comprises a first inductor and a first capacitor, wherein the first inductor is connected between the third terminal and the fifth terminal, and the first capacitor is connected between the third terminal and the fifth terminal.

12. The dual-band system as claimed in claim 11, wherein a first band-stop frequency of the first band-rejection filter is in the second frequency band.

13. The dual-band system as claimed in claim 12, wherein an inductance of the first inductor is in a range between 1 nH and 10 nH, and a capacitance of the first capacitor is in a range between 0.1 pF and 2 pF.

14. The dual-band system as claimed in claim 13, wherein the first capacitor is a parasitic capacitor of the first inductor.

15. The dual-band system as claimed in claim 11, wherein the second filter is a second band-rejection filter for stopping the first band signal.

16. The dual-band system as claimed in claim 15, wherein the second band-rejection filter comprises a second inductor and a second capacitor, wherein the second inductor is connected between the fourth terminal and the fifth terminal, and the second capacitor is connected between the fourth terminal and the fifth terminal.

17. The dual-band system as claimed in claim 16, wherein a second band-stop frequency of the second band-rejection filter is in the first frequency band.

18. The dual-band system as claimed in claim 17, wherein an inductance of the second inductor is in a range between 1 nH and 10 nH, and a capacitance of the second capacitor is in a range between 0.1 pF and 5 pF.

19. The dual-band system as claimed in claim 10, wherein the first matching circuit includes a first conducting wire, and the second matching circuit includes a second conducting wire.
